(19) United States
(12) Patent Application Publication
(10) Pub. No.: US 2024/0412121 A1
(43) Pub. Date: Dec. 12, 2024

(54) PERSONAL INFORMATION UTILIZATION FOR COMMUNITY ENHANCEMENT SYSTEM

(71) Applicant: Carlos Blanco Sanchez, Miami, FL (US)

(72) Inventor: Carlos Blanco Sanchez, Miami, FL (US)

(21) Appl. No.: 18/736,013

(22) Filed: Jun. 6, 2024

Related U.S. Application Data
(60) Provisional application No. 63/506,644, filed on Jun. 7, 2023.

(51) Int. Cl. G06Q 10/04; G06Q 10/1053; G06Q 50/00

(52) U.S. Cl. CPC G06Q 10/04; G06Q 10/1053; G06Q 50/01

(57) ABSTRACT

A method may include hosting a web application having one or more software modules operating within a network, where the one or more software modules may include at least an input module, an analysis module, an optimization module, and a feedback module. In addition, the method may include controlling access of the one or more software modules to two or more data storage devices via independent data access layers of the network, collecting personal information of community members through the input module, processing the collected data using the analysis module to identify trends, patterns, and opportunities for optimizing personal attributes and community interactions, generating optimization strategies based on the analyzed data using the optimization module, receiving user feedback on the implemented strategies via the feedback module and refining the optimization strategies based on the received feedback to continuously improve and adapt the system to evolving community dynamics.

### CROSS-REFERENCE TO RELATED APPLICATION

This Patent application claims priority to U.S. Provisional Patent Application No. 63/506,644, filed on 7 Jun. 2023, and entitled “PERSONAL INFORMATION UTILIZATION FOR COMMUNITY ENHANCEMENT SYSTEM”. The disclosure of the prior Application is considered part of and is incorporated by reference into this Patent Application.

### FIELD OF THE DISCLOSURE

The present disclosure relates generally to data processing and, more specifically, to a software program that optimizes unique personal and socio-economic attributes of individuals within a community through personal information.

### BACKGROUND

With the advancement of technology and the growing importance of social cohesion, there is an increasing need for sophisticated systems that can analyze and optimize individual attributes to enhance community engagement, civic involvement, and economic growth. Existing systems, however, do not offer a comprehensive and adaptable approach to meet these challenges.

### SUMMARY

The present disclosure provides a software program that uses personal information of community members to optimize different personal and unique attributes, such as income, community engagement, social activity, and civic engagement. The community can comprise a city, a town, or an apartment building. The jobs can include service jobs, manufacturing jobs, side gigs, and the like. The software can be hosted on a mobile device, a laptop, or other computing devices.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, computer-implemented method may include hosting a web application having one or more software modules operating within a network, where the one or more software modules may include at least an input module, an analysis module, an optimization module, and a feedback module. The computer-implemented method may also include controlling access of the one or more software modules to two or more data storage devices via independent data access layers of the network. The method may furthermore include collecting personal information of community members through the input module, where the personal information includes income, employment status, social activity, and civic engagement and may include collected data. The method may in addition include processing the collected data using the analysis module to identify trends, patterns, and opportunities for optimizing personal attributes and community interactions to produce analyzed data. The method may moreover include generating optimization strategies based on the analyzed data using the optimization module, where the optimization strategies include job recommendations, social activity suggestions, and initiatives to boost civic participation. The method may also include f. receiving user feedback on the optimization strategies via the feedback module to produce received feedback. The method may furthermore include g. refining the optimization strategies based on the received feedback to continuously improve and adapt the computer-implemented method to evolving community dynamics. Other embodiments of this aspect include corresponding computer systems, apparatus, and computer programs recorded on one or more computer storage devices, each configured to perform the actions of the methods.

Implementations may include one or more of the following features. The computer-implemented method where the input module collects data through a smartphone interface. The computer-implemented method where the analysis module employs machine learning algorithms to process the collected data. The computer-implemented method where the optimization module generates customized solutions tailored to individual attributes and community needs. The computer-implemented method may include deploying the one or more software modules on various types of computing devices to ensure accessibility for all community members. Implementations of the described techniques may include hardware, a method or process, or a computer tangible medium.

In one general aspect, a computer program product may include a tangible computer-readable medium having executable instructions for community engagement and optimization, the executable instructions configured to implement a web application hosted by a server on a network, receive received data corresponding to community members from two or more data storage devices accessed via independent data access layers of the network, collect personal information of community members through an input module, where the personal information includes income, employment status, social activity, and civic engagement, where the received data and personal information to form a collected data, process the collected data using an analysis module to identify trends, patterns, and opportunities for optimizing personal attributes and community interactions to produce analyzed data, generate optimization strategies based on the analyzed data using an optimization module, where the optimization strategies include job recommendations, social activity suggestions, and initiatives to boost civic participation, receive user feedback on the optimization strategies via a feedback module to produce received feedback; and refine the optimization strategies based on the received feedback to continuously improve and adapt computer program product to evolving community dynamics. Other embodiments of this aspect include corresponding computer systems, apparatus, and computer programs recorded on one or more computer storage devices, each configured to perform the actions of the methods.

Implementations may include one or more of the following features. A computer program product where the input module collects data through a smartphone interface. The computer program product where the analysis module employs machine learning algorithms to process the collected data. The computer program product where the optimization module generates customized solutions tailored to individual attributes and community needs. The computer program product may include executable instructions for deploying the web application on various types of computing devices to ensure accessibility for all community members. Implementations of the described techniques may include hardware, a method or process, or a computer tangible medium.

In one general aspect, a system may include a server hosting a web application having one or more software modules configured to operate within a network, where the one or more software modules may include at least an input module, an analysis module, an optimization module, and a feedback module. The system may also include b. two or more data storage devices coupled to the server via independent data access layers of the network, each data access layer configured to control access of the web application to one of the data storage devices. The system may furthermore include c. the input module configured to collect personal information of community members, where the personal information includes income, employment status, social activity, and civic engagement and may include collected data. The system may in addition include the analysis module configured to process the collected data to identify trends, patterns, and opportunities for optimizing personal attributes and community interactions to produce analyzed data. The system may moreover include the optimization module configured to generate optimization strategies based on the analyzed data, where the optimization strategies include job recommendations, social activity suggestions, and initiatives to boost civic participation. The system may also include the feedback module configured to receive user feedback on the optimization strategies to form received feedback. The system may furthermore include the system configured to refine the optimization strategies based on the received feedback to continuously improve and adapt the system to evolving community dynamics. Other embodiments of this aspect include corresponding computer systems, apparatus, and computer programs recorded on one or more computer storage devices, each configured to perform the actions of the methods.

Implementations may include one or more of the following features. The system where the input module collects data through a smartphone interface. The system where the analysis module employs machine learning algorithms to process the collected data. The system where the optimization module generates customized solutions tailored to individual attributes and community needs. The system where the server is further configured to deploy the web application on various types of computing devices to ensure accessibility for all community members. Implementations of the described techniques may include hardware, a method or process, or a computer tangible medium.

### BRIEF DESCRIPTION OF THE DRAWINGS

FIG. 1 is a block diagram of a system overview depicting the overall architecture of a system, showing a central unit and various modules in accordance with the present disclosure.

FIG. 2 is a functional diagram of user interface input module and analysis module in accordance with the present disclosure.

FIG. 3 is a block diagram of an analysis module for processing data from the input module like data cleaning, pattern recognition, and trend analysis in accordance with the present disclosure.

FIG. 4 is a functional block diagram of an optimization module receiving analyzed data and generating personalized strategies for community enhancement in accordance with the present disclosure.

FIG. 5 is a functional block diagram of a feedback module depicting how user feedback is collected, analyzed, and utilized to refine the optimization strategies in accordance with the present disclosure.

FIG. 6 is a front view of an example of computing device for deploying software and user interfaces in accordance with the present disclosure.

FIG. 7 is an example of a home screen of the input module of FIG. 2 in accordance with the present disclosure.

FIG. 8 is an example of a services screen of the input module of FIG. 2 in accordance with the present disclosure.

FIG. 9 is an example of an investing screen of the input module of FIG. 2 in accordance with the present disclosure.

FIG. 10 is an example of an earn income screen of the input module of FIG. 2 in accordance with the present disclosure.

FIG. 11 is an example of a community screen of the input module of FIG. 2 in accordance with the present disclosure.

### DETAILED DESCRIPTION

The present disclosure provides a method, a computer program product and a system comprising a community engagement system software based system including hardware, non-volatile memory, tangible computer readable medium, and users that employs personal data of community members to optimize various personal attributes and engagement within the community.

The term “coupled” is defined as connected, although not necessarily directly, and not necessarily mechanically.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements but is not limited to possessing only those one or more elements. Likewise, a step of a method or an element of a device that “comprises,” “has,” “includes” or “contains” one or more features possesses those one or more features but is not limited to possessing only those one or more features. Furthermore, a device or structure that is configured in a certain way is configured in at least that way, but may also be configured in ways that are not listed.

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

Certain units described in this specification have been labeled as modules, in order to more particularly emphasize their implementation independence. A module is “[a] self-contained hardware or software component that interacts with a larger system.” Alan Freedman, “The Computer Glossary” 268 (8th ed. 1998). A module comprises a machine or machines including tangible computer readable mediums having executable instructions. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also include software-defined units or instructions, that when executed by a processing machine or device, transform data stored on a data storage device from a first state to a second state. An identified module of executable code may, for instance, comprise one or more physical or logical blocks of computer instructions which may be organized as an object, procedure, or function. Nevertheless, the executables of an identified module need not be physically located together, but may comprise disparate instructions stored in different locations which, when joined logically together, comprise the module, and when executed by the processor, achieve the stated data transformation.

Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices.

In the following description, numerous specific details are provided, such as examples of programming, software modules, user selections, network transactions, database queries, database structures, hardware modules, hardware circuits, hardware chips, etc., to provide a thorough understanding of the present embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

### 4.1 System Architecture

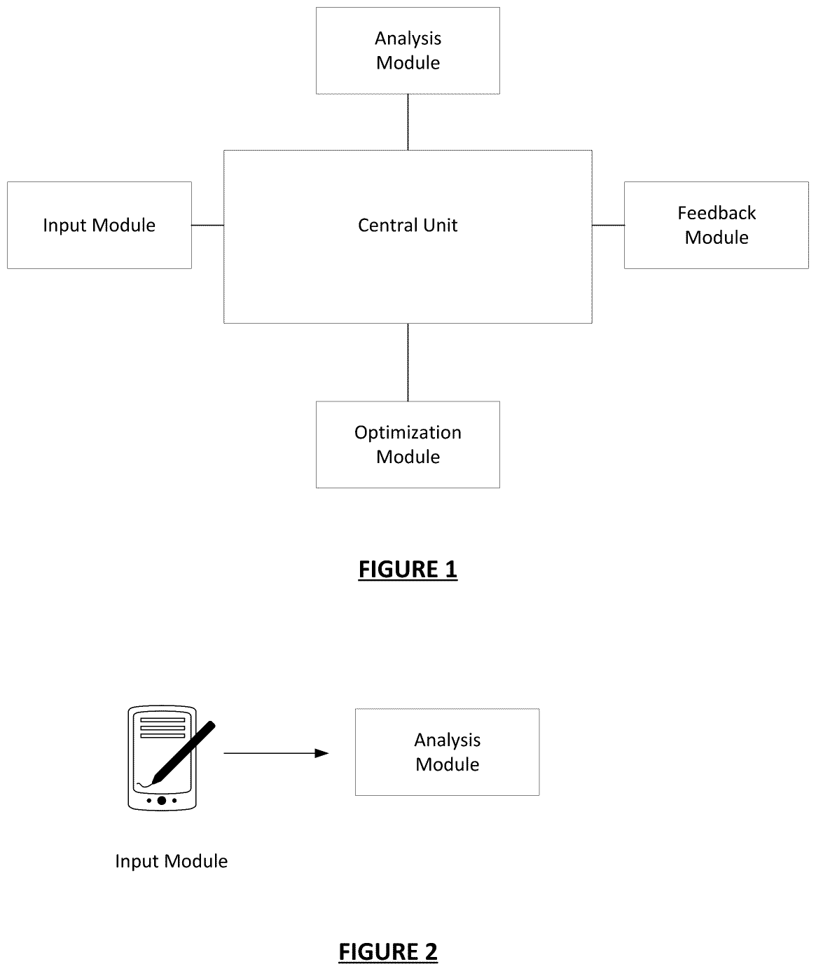

As shown in FIG. 1, the community engagement system 1 encompasses several modules: an Input Module 2, an Analysis Module 3, an Optimization Module 4, a Feedback Module 5, all variously connected to Central Unit 6 and functioning together to form a comprehensive, adaptable system community engagement system. The various modules can be referred to herein as software modules and physically reside together, in the cloud or as part of independent data access layers stored on memory devices on the various modules. Central unit 6 can comprise a central processing unit and can be used to control access of the one or more software modules to two or more data storage devices via independent data access layers of the network.

### 4.1.1 Input Module

As depicted in FIG. 2, input module 2 is depicted by a smartphone wherein the input module is configured for collecting personal information of community members via a smartphone interface. Data can be gathered through different interfaces, like user profiles, surveys, or direct user input. This data can include income, employment status, social activity, social activity suggestions, civic engagement, and other relevant socio-economic information. Privacy and data security measures are implemented to ensure ethical and lawful data collection and storage. Input module 2 is shown connected to analysis module 3.

### 4.1.2 Analysis Module

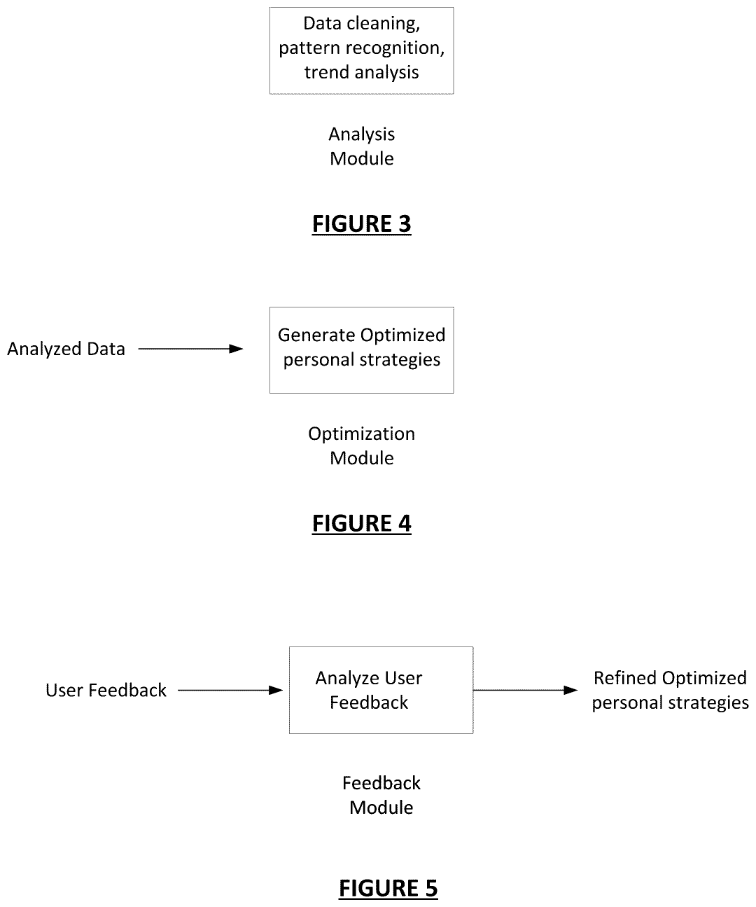

As illustrated in FIG. 3, analysis module 3 receives the data from the Input Module 2 (FIG. 2) and processes it using advanced algorithms. The algorithms of analysis module 3 identifies trends, patterns, and opportunities for optimizing personal attributes and community interactions. For example, analysis module 3 can identify members with specific skill sets for particular jobs or highlight areas of the community where civic engagement could be improved. The analysis module 3 can employ various machine learning algorithms and statistical techniques to generate meaningful insights from the gathered data. Such algorithms can include the following as an example:
Maximize W=f (Ic, Ig)
Subject to ΣIc=Σ(wc*Tc) and ΣIg=Σ(wg*Tg) over all tenants of a community.
Time Constraint: Each tenant has a limited amount of time, T, which they can spend on community work, Tc, and gig work, Tg. This can be represented as:

$$T = T c + T g$$

Income Function: Each tenant's total income, I, is the sum of income from community work, Ic, and income from gig work, Ig. This can be expressed as:

$$I = I c + I g$$

Where Ic=wc*Tc and Ig=wg*Tg. Here, wc represents the rate of income from community work and wg represents the rate of income from gig work.
Well-Being Function: The well-being of the community, W, is a function of the total income generated within the community and the income generated from gig jobs. This could be expressed as:

W=f(Ic,Ig)
The specific form of f ( ) (function of) would depend on how community well-being is defined and how it is affected by internal and external income.
Optimization Problem: Each tenant's goal could be to maximize their income subject to their time constraint. This could be represented as:

$$Maximize I = wc * Tc + wg * Tg$$

$$Subject to T = Tc + T g$$

Community Goal: The community's goal could be to maximize well-being subject to the total community income and time. This could be represented as:

Maximize W=f(Ic,Ig)
Subject to ΣIc=ρ(wc*Tc) and ΣIg=μ(wg*Tg) over all tenants.

### 4.1.3 Optimization Module

Upon receiving the analyzed data from analysis module 3, as shown in FIG. 4, the Optimization Module 4 generates and implements optimization strategies. These strategies could involve job recommendations based on individual skill sets, suggesting social activities to improve community engagement, or initiatives to boost civic participation. This module is designed to provide customized solutions tailored to individual attributes and community needs.

### 4.1.4 Feedback Module

As represented in FIG. 5, the Feedback Module 5 is configured for the community engagement system's 1 (FIG. 1) adaptability and growth. Feedback Module 5 allows community members to provide user feedback via input module 2 on the implemented strategies and their outcomes. This feedback is then used by algorithms within Feedback Module 5 to refine and adjust the optimization strategies, ensuring the community engagement system continuously improves and adapts to the evolving community dynamics.

### 4.2 Software Deployment

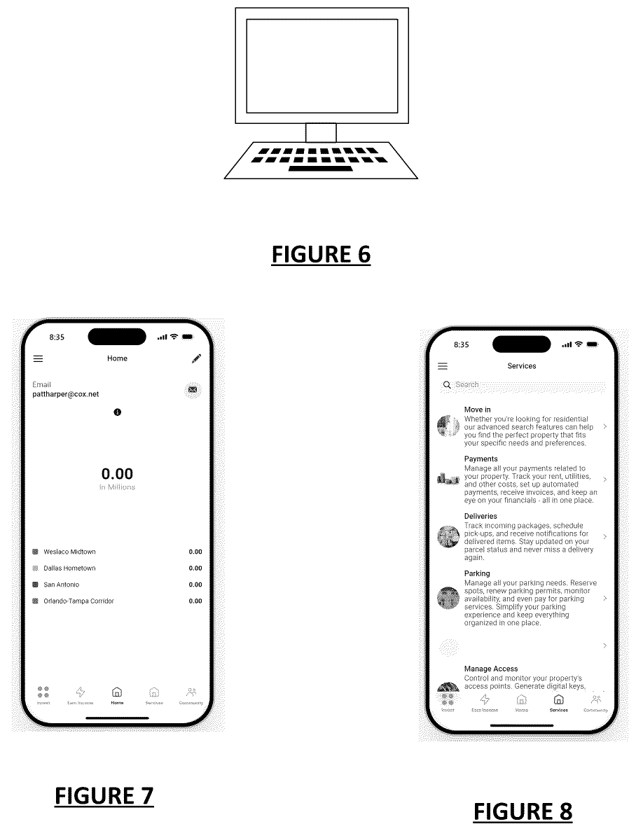

As depicted in FIG. 6, the community engagement system software program of the community engagement system 1 can be hosted on various types of computing devices, such as desktop computing system 7 as well as mobile devices, laptops, and servers. The versatility of the software deployment ensures accessibility to the community engagement system for all community members. The community engagement system of the current disclosure allows for scalability, capable of serving communities ranging from a small apartment building to an entire city.

### 4.3 Implementation Examples

In a service job scenario, the community engagement system might identify community members with hospitality skills who are currently unemployed or underemployed. The community engagement system could then suggest job opportunities within the community that match these skills, thereby optimizing income potential and employment status for these individuals.

In a civic engagement scenario, the community engagement system might identify that participation in local government or community events is lower in certain demographic groups within the community. The community engagement system could then suggest targeted initiatives to increase civic engagement within these groups, such as outreach programs, workshops, or mentorship schemes.

The present disclosure's versatility and adaptability make the community engagement system a robust tool for enhancing personal attributes, fostering community engagement, and promoting overall community growth.

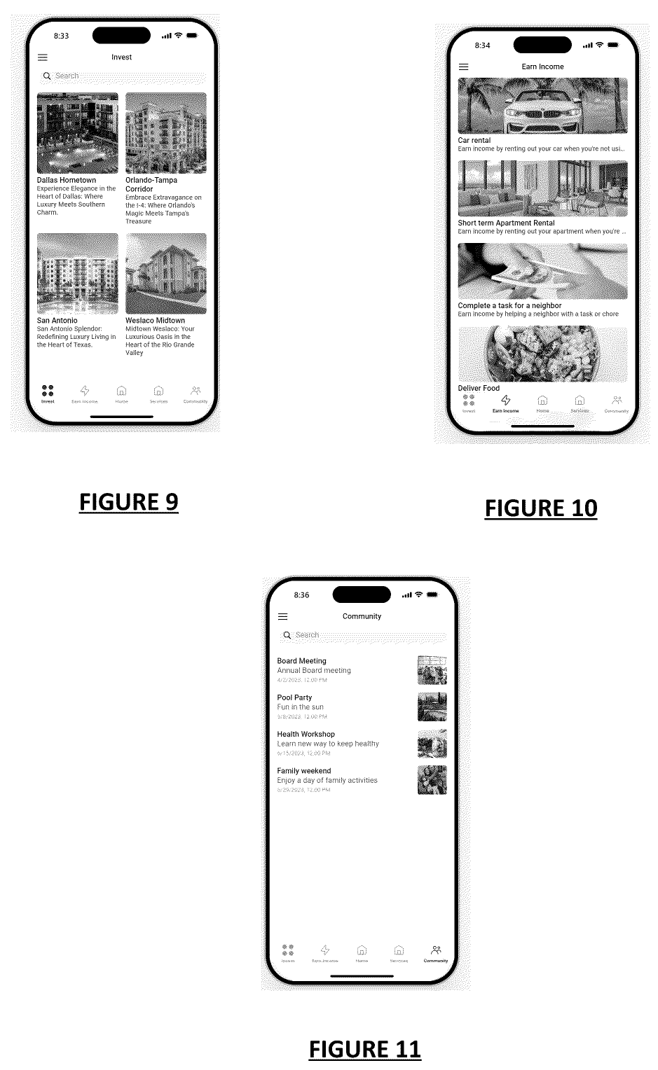

With reference to FIGS. 7-11, there are shown examples of various screen shots of embodiments of the present disclosure presented to a user of the community engagement system. For instance, FIG. 7 shows an example of a home screen 8 of a user of the community engagement system on the smartphone interface of a smartphone 9 in accordance with the present disclosure. FIG. 8 shows an example of a service screen 10 of a user of the community engagement system on the smartphone interface of a smartphone 9 in accordance with the present disclosure. FIG. 9 shows an example of an investment screen 11 of a user of the community engagement system on the smartphone interface of a smartphone 9 in accordance with the present disclosure.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method for community engagement and optimization, comprising:
a. hosting a web application comprising one or more software modules operating within a network, wherein the one or more software modules comprise at least an input module, an analysis module, an optimization module, and a feedback module;
b. controlling access of the one or more software modules to two or more data storage devices via independent data access layers of the network;
c. collecting personal information of community members through the input module, wherein the personal information includes income, employment status, social activity, and civic engagement and comprises collected data;
d. processing the collected data using the analysis module to identify trends, patterns, and opportunities for optimizing personal attributes and community interactions to produce analyzed data;
e. generating optimization strategies based on the analyzed data using the optimization module, wherein the optimization strategies include job recommendations, social activity suggestions, and initiatives to boost civic participation;
f. receiving user feedback on the optimization strategies via the feedback module to produce received feedback; and
g. refining the optimization strategies based on the received feedback to continuously improve and adapt the computer-implemented method to evolving community dynamics.

2. The computer-implemented method of claim 1, wherein the input module collects data through a smartphone interface.

3. The computer-implemented method of claim 1, wherein the analysis module employs machine learning algorithms to process the collected data.

4. The computer-implemented method of claim 1, wherein the optimization module generates customized solutions tailored to individual attributes and community needs.

5. The computer-implemented method of claim 1, further comprising deploying the one or more software modules on various types of computing devices to ensure accessibility for all community members.

6. A computer program product comprising:
a. a tangible computer-readable medium comprising executable instructions for community engagement and optimization, the executable instructions configured to:
i. implement a web application hosted by a server on a network;
ii. receive received data corresponding to community members from two or more data storage devices accessed via independent data access layers of the network;
iii. collect personal information of community members through an input module, wherein the personal information includes income, employment status, social activity, and civic engagement;
iv, wherein the received data and personal information to form a collected data, process the collected data using an analysis module to identify trends, patterns, and opportunities for optimizing personal attributes and community interactions to produce analyzed data;
v. generate optimization strategies based on the analyzed data using an optimization module, wherein the optimization strategies include job recommendations, social activity suggestions, and initiatives to boost civic participation;
vi. receive user feedback on the optimization strategies via a feedback module to produce received feedback; and
vii. refine the optimization strategies based on the received feedback to continuously improve and adapt computer program product to evolving community dynamics.

7. The computer program product of claim 6, wherein the input module collects data through a smartphone interface.

8. The computer program product of claim 6, wherein the analysis module employs machine learning algorithms to process the collected data.

9. The computer program product of claim 6, wherein the optimization module generates customized solutions tailored to individual attributes and community needs.

10. The computer program product of claim 6, further comprising executable instructions for deploying the web application on various types of computing devices to ensure accessibility for all community members.

11. A system for community engagement and optimization, comprising:
a. a server hosting a web application comprising one or more software modules configured to operate within a network, wherein the one or more software modules comprise at least an input module, an analysis module, an optimization module, and a feedback module;
b. two or more data storage devices coupled to the server via independent data access layers of the network, each data access layer configured to control access of the web application to one of the data storage devices;
c. the input module configured to collect personal information of community members, wherein the personal information includes income, employment status, social activity, and civic engagement and comprises collected data;
d. the analysis module configured to process the collected data to identify trends, patterns, and opportunities for optimizing personal attributes and community interactions to produce analyzed data;
e. the optimization module configured to generate optimization strategies based on the analyzed data, wherein the optimization strategies include job recommendations, social activity suggestions, and initiatives to boost civic participation;
f. the feedback module configured to receive user feedback on the optimization strategies to form received feedback; and
g. the system configured to refine the optimization strategies based on the received feedback to continuously improve and adapt the system to evolving community dynamics.

12. The system of claim 11, wherein the input module collects data through a smartphone interface.

13. The system of claim 11, wherein the analysis module employs machine learning algorithms to process the collected data.

14. The system of claim 11, wherein the optimization module generates customized solutions tailored to individual attributes and community needs.

15. The system of claim 11 wherein the server is further configured to deploy the web application on various types of computing devices to ensure accessibility for all community members.
